(19) United States
(12) Patent Application Publication
(10) Pub. No.: US 2025/0302084 A1
(43) Pub. Date: Oct. 2, 2025

(54) EFFICIENT MOWING MACHINE

(71) Applicant: Fenggeng Guo, Shenzhen City (CN)

(72) Inventor: Fenggeng Guo, Shenzhen City (CN)

(73) Assignee: Shenzhen Huayu Agricultural Technology Co., Ltd., Shenzhen (CN)

(21) Appl. No.: 18/622,930

(22) Filed: Mar. 30, 2024

(51) Int. Cl. A23N 17/02

(52) U.S. Cl. CPC A23N 17/02

(57) ABSTRACT

Disclosed is an efficient mowing machine, including a tumbling and cutting assembly, where the tumbling and cutting assembly includes a tumbling barrel, a rolling motor, a transmission shaft, rolling members, a trimming mesh plate, a rotating seat, a driving bevel gear, a limiting seat, two driven bevel gears and two rotating shafts. Fodder needing to be cut is put into the tumbling barrel, the rolling motor drives the transmission shaft to rotate, the transmission shaft drives the rotating seat to rotate, the driven bevel gears move circularly on a tooth surface of the driving bevel gear through teeth and rotate by themselves, such that the rolling members are driven to rotate and make the fodder rolled over, a discharging hole is formed on the trimming mesh plate, the fodder protrudes through the discharging hole on the trimming mesh plate, and the fodder can be cut.

### TECHNICAL FIELD

The present disclosure belongs to the technical field of mowing machine, relates to a mowing machine, and particularly relates to an efficient mowing machine.

### BACKGROUND

A mowing machine is a mechanical tool with functions of cutting and collecting fodder. During operation, the mowing machine puts the fodder into a tumbling bin, a tumbling mechanism rolls over the fodder to enable the fodder to fall into a bottom cutting bin, and a cutting mechanism then cuts the fodder. The mowing machine has the following advantages:

Efficient cutting: The cutting mechanism can cut the fodder quickly and accurately, improving work efficiency.

Automatic rolling: The tumbling mechanism can automatically roll the fodder, making the fodder fall into the cutting bin more evenly and improving cutting effect.

Large-capacity collection: The bottom cutting bin can accommodate a large amount of fodder, reducing the need for frequent cleaning.

Simple operation: The mowing machine has a simple structure, making it easy to operate, maintain and repair.

The tumbling mechanism of the existing mowing machine consists of an upright rotating shaft with a support rod on it, and a plurality of rubber strips are arranged on the support rod, when the rotating shaft rotates, all the rubber strips are driven to rotate, and the fodder inside the bin is driven to roll over. However, the tumbling mechanism in the prior art always cause the fodder to accumulate at a bottom of the tumbling bin, leading to blockage of knife holes at the bottom of tumbling bin, which affects the cutting of the fodder and the working efficiency. Therefore, it is necessary to provide an efficient mowing machine.

### SUMMARY

In view of the foregoing problems, the present disclosure provides an efficient mowing machine to address or alleviate the technical problems in the prior art, and at least provide a beneficial alternative.

The present disclosure adopts the following technical solution: an efficient mowing machine, including a tumbling and cutting assembly, where the tumbling and cutting assembly includes a tumbling barrel, a rolling motor, a transmission shaft, rolling members, a trimming mesh plate, a rotating seat, a driving bevel gear, a limiting seat, two driven bevel gears, two rotating shafts, and a fixing disk; and

the rolling motor is installed at a center of an upper surface of the tumbling barrel, a top of the transmission shaft is fixedly connected to an output shaft of the rolling motor through a coupling, the driving bevel gear is fixedly connected to the transmission shaft through a pin, the transmission shaft is installed on an upper surface of the trimming mesh plate through the fixing disk, outer side walls of the two driven bevel gears are symmetrically connected to a lower surface of the driving bevel gear in a meshing manner, the two driven bevel gears are connected to the limiting seat through the two rotating shafts, two rolling members are symmetrically and fixedly connected to far ends of the two driven bevel gears, and the rotating seat is installed on a center of the upper surface of the trimming mesh plate.

Further preferably, the limiting seat is fixedly connected to an inside of the rotating seat, a bottom end of the transmission shaft is rotationally connected to the center of the upper surface of the trimming mesh plate, shafts of the two rolling members are symmetrically and rotationally connected to the inside of the rotating seat, the driven bevel gears are rotationally connected to the inside of the rotating seat, and the rolling members are cylindrical, block-shaped or polygonal.

Further preferably, the tumbling and cutting assembly further includes an electric appliance box, three fan blades, support frames, a circular blade, a cutting motor, and two feeding doors; and

the electric appliance box is installed on the upper surface of the tumbling barrel, the rolling motor is installed inside the electric appliance box, and the two feeding doors are symmetrically installed on the upper surface of the tumbling barrel.

Further preferably, the three fan blades are symmetrically installed on an output shaft of the cutting motor, and the output shaft of the cutting motor is fixedly connected to a center of a lower surface of the circular blade.

Further preferably, the cutting motor is installed inside the support frames, the fan blades are located below the circular blade, and the circular blade is located below the trimming mesh plate.

Further preferably, a housing is installed on an outer side wall of the tumbling barrel, where the housing includes a first housing assembly and a second housing assembly, and the first housing assembly includes a first housing, a fodder storage mesh, a first base, and four first universal wheels; and

the trimming mesh plate and the outer side wall of the tumbling barrel are both fixedly connected to an inner side wall of the first housing, the fodder storage mesh is installed at a bottom of the first housing and is communicated with the first housing, and the support frames are all installed on an inner side wall of the fodder storage mesh.

Further preferably, the fodder storage mesh is installed at the bottom of the first housing, and the four first universal wheels are symmetrically installed on a lower surface of the first base.

Further preferably, the second housing assembly includes a second housing, four support rods, two second bases, and two second universal wheels; and

the trimming mesh plate and the tumbling barrel are both fixedly connected to an inner side wall of the second housing, and the support frames are all installed on the inner side wall of the second housing.

Further preferably, top ends of the four support rods are symmetrically and fixedly connected to a lower surface of the second housing, and bottom ends of the four support rods are symmetrically and fixedly connected to lower surfaces of the two second bases.

Further preferably, the two second universal wheels are symmetrically and fixedly connected to the lower surface of the second base.

Embodiments of the present disclosure adopt the above technical solutions and have the following advantages: fodder needing to be cut is put into the tumbling barrel, the rolling motor drives the transmission shaft to rotate, the transmission shaft drives the rotating seat to rotate, the driven bevel gears move circularly on a tooth surface of the driving bevel gear through teeth and rotate by themselves, such that the rolling members are driven to rotate, and the rolling members make the fodder rolled over, enabling the fodder on the trimming mesh plate distributed evenly; a discharging hole is formed on the trimming mesh plate, the fodder protrudes through the discharging hole on the trimming mesh plate, and the fodder can be cut; continuous rolling of the rolling members makes the fodder rolled over, and unwanted branches and leaves on the fodder protrude through meshes on the trimming mesh plate, such that each side of the fodder can be trimmed and cut well without crushing or damaging the fodder.

The above summary is for illustration purposes only and is not intended to be limiting in any way. In addition to the illustrative aspects, embodiments, and features described above, further aspects, embodiments, and features of the present disclosure will be readily apparent by reference to the accompanying drawings and the following detailed description.

### BRIEF DESCRIPTION OF THE DRAWINGS

In order to more clearly illustrate technical solutions in the embodiments of the present disclosure or in the prior art, a brief introduction to the accompanying drawings required for the description of the embodiments or the prior art will be provided below. Obviously, the accompanying drawings in the following description are only some of the embodiments of the present disclosure, and those ordinarily skilled in the art would also be able to derive other drawings from these drawings without making creative efforts.

FIG. 1 is a structural diagram of the present disclosure.

FIG. 2 is a structural diagram of a tumbling and cutting assembly of the present disclosure.

FIG. 3 is a structural diagram of a rolling member of the present disclosure.

FIG. 4 is a structural diagram of a fixing disk of the present disclosure.

FIG. 5 is a schematic diagram of connection between a driving bevel gear and a driven bevel gear of the present disclosure.

FIG. 6 is a structural diagram of a circular blade of the present disclosure.

FIG. 7 is a structural diagram of a second housing assembly of the present disclosure.

FIG. 8 is a structural diagram of a second housing of the present disclosure.

Reference numerals in the accompanying drawings: 101. tumbling and cutting assembly; 11. tumbling barrel; 12. electric appliance box; 13. fan blade; 14. support frame; 15. rolling motor; 16. transmission shaft; 17. rolling member; 18. trimming mesh plate; 19. rotating seat; 20. driving bevel gear; 22. limiting seat; 23. driven bevel gear; 24. rotating shaft; 25. circular blade; 26. cutting motor; 27. feeding door; 28. fixing disk; 30. housing; 301. first housing assembly; 31. first housing; 32. fodder storage mesh; 33. first base; 34. first universal wheel; 401. second housing assembly; 41. second housing; 42. support rod; 43. second base; and 44. second universal wheel.

### DETAILED DESCRIPTIONS OF THE EMBODIMENTS

Some exemplary embodiments are simply described below. As those skilled in the art could recognize, the described embodiments may be modified in various different ways without departing from the spirit or scope of the present disclosure. Accordingly, the drawings and description are to be regarded as illustrative, but not restrictive, in nature.

The present disclosure will be elaborated hereafter in conjunction with the accompanying drawings.

### Embodiment 1

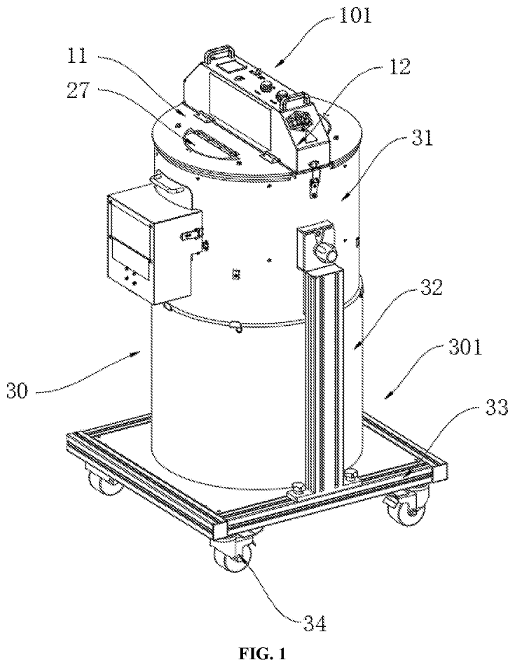

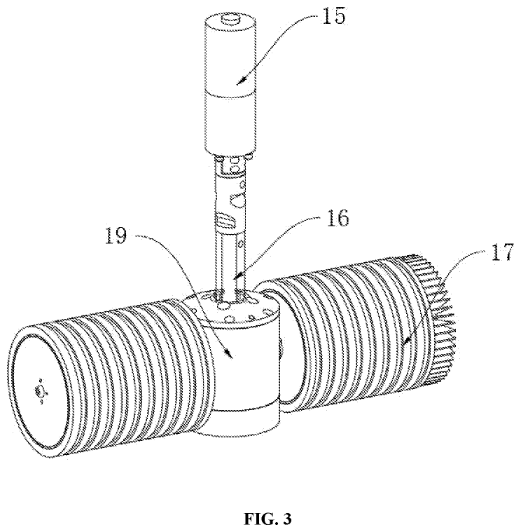

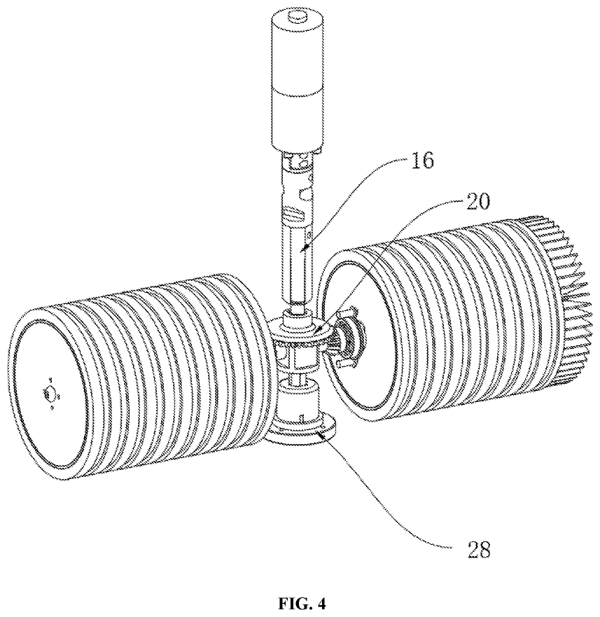

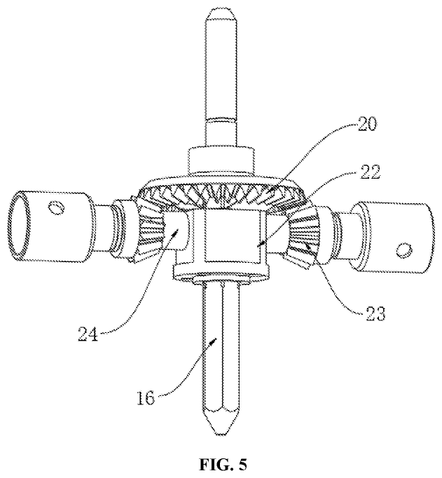

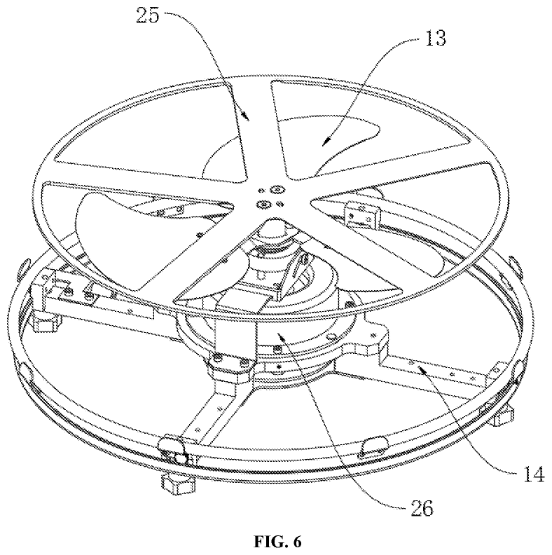

As shown in FIGS. 1-6, an example of the present disclosure provides an efficient mowing machine, including a tumbling and cutting assembly 101, where the tumbling and cutting assembly 101 includes a tumbling barrel 11, a rolling motor 15, a transmission shaft 16, rolling members 17, a trimming mesh plate 18, a rotating seat 19, a driving bevel gear 20, a limiting seat 22, two driven bevel gears 23, two rotating shafts 24, and a fixing disk 28; and

the rolling motor 15 is installed at a center of an upper surface of the tumbling barrel 11, a top of the transmission shaft 16 is fixedly connected to an output shaft of the rolling motor 15 through a coupling, the driving bevel gear 20 is fixedly connected to the transmission shaft 16 through a pin, the transmission shaft 16 is installed on an upper surface of the trimming mesh plate 18 through the fixing disk 28, outer side walls of the two driven bevel gears 23 are symmetrically connected to a lower surface of the driving bevel gear 20 in a meshing manner, the two driven bevel gears 23 are connected to the limiting seat 22 through the two rotating shafts 24, two rolling members 17 are symmetrically and fixedly connected to far ends of the two driven bevel gears 23, and the rotating seat 19 is installed on a center of the upper surface of the trimming mesh plate 18.

In one embodiment, the rolling members 17 are cylindrical. In practical application, gear shaping machines of different shapes can be replaced according to different types of fodder, or the rolling members 17 may be directly used to toggle the fodder to roll over. The rolling members 17 may also be block-shaped or polygonal.

In one embodiment, the limiting seat 22 is fixedly connected to an inside of the rotating seat 19, a bottom end of the transmission shaft 16 is rotationally connected to the center of the upper surface of the trimming mesh plate 18, shafts of the two rolling members 17 are symmetrically and rotationally connected to the inside of the rotating seat 19, the driven bevel gears 23 are rotationally connected to the inside of the rotating seat 19, the transmission shaft 16 drives the rotating seat 19 to rotate, and the driven bevel gears 23 move circularly on a tooth surface of the driving bevel gear 20 through teeth and rotate by themselves, such that the rolling members 17 are driven to rotate, and the rolling members 17 can make the fodder on the trimming mesh plate 18 rolled over.

In one embodiment, the tumbling and cutting assembly 101 further includes an electric appliance box 12, three fan blades 13, support frames 14, a circular blade 25, a cutting motor 26, and two feeding doors 27; and

the electric appliance box 12 is installed on the upper surface of the tumbling barrel 11, the rolling motor 15 is installed inside the electric appliance box 12, the two feeding doors 27 are symmetrically installed on the upper surface of the tumbling barrel 11, the three fan blades 13 are symmetrically installed on an output shaft of the cutting motor 26, the output shaft of the cutting motor 26 is fixedly connected to a center of a lower surface of the circular blade 25, the cutting motor 26 is installed inside the support frames 14, the fan blades 13 are located below the circular blade 25, the circular blade 25 is located below the trimming mesh plate 18, the cutting motor 26 drives the circular blade 25 and the fan blades 13 to rotate, and the circular blade 25 is in contact with the fodder when it rotates at a high speed, such that cutting action of the fodder is implemented; and at the same time, the cutting motor 26 drives the fan blades 13 to rotate, air flow generated by the fan blades 13 can play a guiding role, and cut fodder is collected into a fodder storage mesh 32.

In one embodiment, a housing 30 is installed on an outer side wall of the tumbling barrel 11, where the housing 30 includes a first housing assembly 301 and a second housing assembly 401, and the first housing assembly 301 includes a first housing 31, a fodder storage mesh 32, a first base 33, and four first universal wheels 34; and

the trimming mesh plate 18 and the outer side wall of the tumbling barrel 11 are both fixedly connected to an inner side wall of the first housing 31, the fodder storage mesh 32 is installed at a bottom of the first housing 31 and is communicated with the first housing 31, the support frames 14 are all installed on an inner side wall of the fodder storage mesh 32, the fodder storage mesh 32 is installed at the bottom of the first housing 31, the four first universal wheels 34 are symmetrically installed on a lower surface of the first base 33, the arrangement of the fodder storage mesh 32 can implement the collection of the cut fodder, and the arrangement of the first base 33 and the four universal wheels 34 facilitate movements of the mowing machine as a whole.

### Embodiment 2

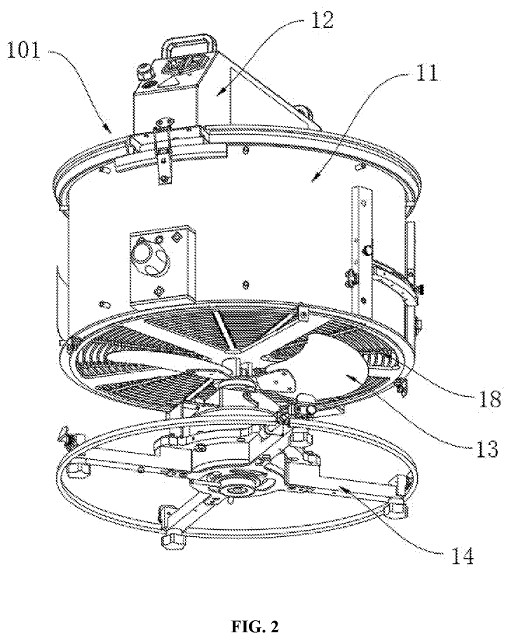

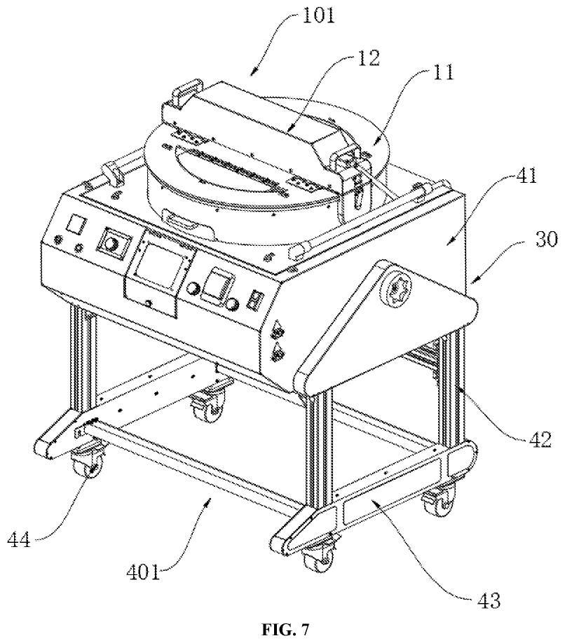

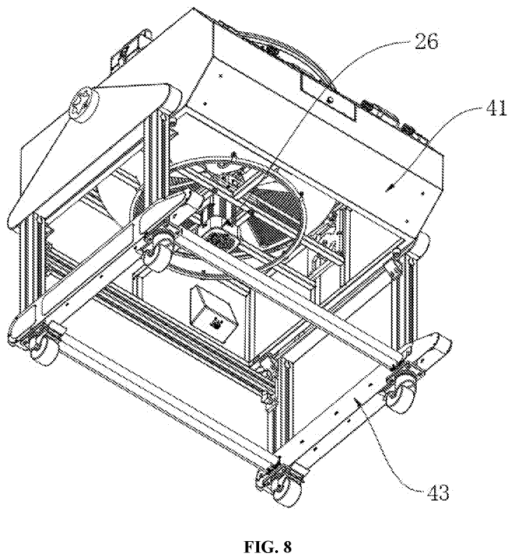

As shown in FIGS. 2-8, an efficient mowing machine, including a tumbling and cutting assembly 101, where the tumbling and cutting assembly 101 includes a tumbling barrel 11, a rolling motor 15, a transmission shaft 16, rolling members 17, a trimming mesh plate 18, a rotating seat 19, a driving bevel gear 20, a limiting seat 22, two driven bevel gears 23, two rotating shafts 24, and a fixing disk 28; and

the rolling motor 15 is installed at a center of an upper surface of the tumbling barrel 11, a top of the transmission shaft 16 is fixedly connected to an output shaft of the rolling motor 15 through a coupling, the driving bevel gear 20 is fixedly connected to the transmission shaft 16 through a pin, the transmission shaft 16 is installed on an upper surface of the trimming mesh plate 18 through the fixing disk 28, outer side walls of the two driven bevel gears 23 are symmetrically connected to a lower surface of the driving bevel gear 20 in a meshing manner, the two driven bevel gears 23 are connected to the limiting seat 22 through the two rotating shafts 24, two rolling members 17 are symmetrically and fixedly connected to far ends of the two driven bevel gears 23, and the rotating seat 19 is installed on a center of the upper surface of the trimming mesh plate 18.

In one embodiment, the limiting seat 22 is fixedly connected to an inside of the rotating seat 19, a bottom end of the transmission shaft 16 is rotationally connected to the center of the upper surface of the trimming mesh plate 18, shafts of the two rolling members 17 are symmetrically and rotationally connected to the inside of the rotating seat 19, the driven bevel gears 23 are rotationally connected to the inside of the rotating seat 19, the transmission shaft 16 drives the rotating seat 19 to rotate, and the driven bevel gears 23 move circularly on a tooth surface of the driving bevel gear 20 through teeth and rotate by themselves, such that the rolling members 17 are driven to rotate, and the rolling members 17 can make the fodder on the trimming mesh plate 18 rolled over.

In one embodiment, the tumbling and cutting assembly 101 further includes an electric appliance box 12, three fan blades 13, support frames 14, a circular blade 25, a cutting motor 26, and two feeding doors 27; and

the electric appliance box 12 is installed on the upper surface of the tumbling barrel 11, the rolling motor 15 is installed inside the electric appliance box 12, the two feeding doors 27 are symmetrically installed on the upper surface of the tumbling barrel 11, the three fan blades 13 are symmetrically installed on an output shaft of the cutting motor 26, the output shaft of the cutting motor 26 is fixedly connected to a center of a lower surface of the circular blade 25, the cutting motor 26 is installed inside the support frames 14, the fan blades 13 are located below the circular blade 25, the circular blade 25 is located below the trimming mesh plate 18, the cutting motor 26 drives the circular blade 25 and the fan blades 13 to rotate, and the circular blade 25 is in contact with the fodder when it rotates at a high speed, such that cutting action of the fodder is implemented.

In one embodiment, a housing 30 is installed on an outer side wall of the tumbling barrel 11, where the housing 30 includes a second housing assembly 401, and the second housing assembly 401 includes a second housing 41, four support rods 42, two second bases 43, and two second universal wheels 44; and

the trimming mesh plate 18 and the tumbling barrel 11 are both fixedly connected to an inner side wall of the second housing 41, the support frames 14 are all installed on the inner side wall of the second housing 41, top ends of the four support rods 42 are symmetrically and fixedly connected to a lower surface of the second housing 41, bottom ends of the four support rods 42 are symmetrically and fixedly connected to lower surfaces of the two second bases 43, the two second universal wheels 44 are symmetrically and fixedly connected to the lower surface of the second base 43, and a bottom of the second housing 41 is an opening, such that a corresponding collection device can be installed below the second housing 41 according to use requirements.

When the mowing machine in the present disclosure is working: the feeding doors 27 are opened, fodder needing to be cut is put into the tumbling barrel 11, the rolling motor 15 drives the transmission shaft 16 to rotate, the transmission shaft 16 drives the rotating seat 19 to rotate, the driven bevel gears 23 move circularly on the tooth surface of the driving bevel gear 20 through teeth and rotate by themselves, such that the rolling members 17 are driven to rotate, and the rolling members 17 make the fodder rolled over, enabling the fodder on the trimming mesh plate 18 distributed evenly; and the fodder protrudes through a discharging hole on the trimming mesh plate 18, continuous rolling of the rolling members 17 makes the fodder rolled over, and unwanted branches and leaves on the fodder protrude through meshes on the trimming mesh plate 18, such that each side of the fodder can be trimmed and cut well without crushing or damaging the fodder; the rolling members 17 can be disassembled, the rolling members 17 of different shapes can be replaced according to the types of fodder, the cutting motor 26 drives the circular blade 25 and the fan blades 13 to rotate, and the circular blade 25 is in contact with the fodder when it rotates at a high speed, such that cutting action of the fodder is implemented; and at the same time, the cutting motor 26 drives the fan blades 13 to rotate, air flow generated by the fan blades 13 can play a guiding role, the fodder is sucked into the trimming mesh plate 18 for cut, and cut fodder is collected into a fodder storage mesh 32.

What is described above is merely specific embodiments of the present disclosure, but a protection scope of the present disclosure is not limited thereto. Various modifications or substitutions that may be easily conceived by any technician familiar with the technical field within the technical scope disclosed by the present disclosure should be covered within the protection scope of the present disclosure. Therefore, the scope of protection of the present disclosure shall be subject to that of the appended claims.

What it claimed is:

1. An efficient mowing machine, comprising a tumbling and cutting assembly, wherein the tumbling and cutting assembly comprises a tumbling barrel, a rolling motor, a transmission shaft, rolling members, a trimming mesh plate, a rotating seat, a driving bevel gear, a limiting seat, two driven bevel gears, two rotating shafts, and a fixing disk; and
the rolling motor is installed at a center of an upper surface of the tumbling barrel, a top of the transmission shaft is fixedly connected to an output shaft of the rolling motor through a coupling, the driving bevel gear is fixedly connected to the transmission shaft through a pin, the transmission shaft is installed on an upper surface of the trimming mesh plate through the fixing disk, outer side walls of the two driven bevel gears are symmetrically connected to a lower surface of the driving bevel gear in a meshing manner, the two driven bevel gears are connected to the limiting seat through the two rotating shafts, two rolling members are symmetrically and fixedly connected to far ends of the two driven bevel gears, and the rotating seat is installed on a center of the upper surface of the trimming mesh plate.

2. The efficient mowing machine according to claim 1, wherein the limiting seat is fixedly connected to an inside of the rotating seat, a bottom end of the transmission shaft is rotationally connected to the center of the upper surface of the trimming mesh plate, shafts of the two rolling members are symmetrically and rotationally connected to the inside of the rotating seat, the driven bevel gears are rotationally connected to the inside of the rotating seat, and the rolling members are cylindrical, block-shaped or polygonal.

3. The efficient mowing machine according to claim 1, wherein the tumbling and cutting assembly further comprises an electric appliance box, three fan blades, support frames, a circular blade, a cutting motor, and two feeding doors; and
the electric appliance box is installed on the upper surface of the tumbling barrel, the rolling motor is installed inside the electric appliance box, and the two feeding doors are symmetrically installed on the upper surface of the tumbling barrel.

4. The efficient mowing machine according to claim 3, wherein the three fan blades are symmetrically installed on an output shaft of the cutting motor, and the output shaft of the cutting motor is fixedly connected to a center of a lower surface of the circular blade.

5. The efficient mowing machine according to claim 4, wherein the cutting motor is installed inside the support frames, the fan blades are located below the circular blade, and the circular blade is located below the trimming mesh plate.

6. The efficient mowing machine according to claim 3, wherein a housing is installed on an outer side wall of the tumbling barrel, wherein the housing comprises a first housing assembly and a second housing assembly, and the first housing assembly comprises a first housing, a fodder storage mesh, a first base, and four first universal wheels; and
the trimming mesh plate and the outer side wall of the tumbling barrel are both fixedly connected to an inner side wall of the first housing, the fodder storage mesh is installed at a bottom of the first housing and is communicated with the first housing, and the support frames are all installed on an inner side wall of the fodder storage mesh.

7. The efficient mowing machine according to claim 6, wherein the fodder storage mesh is installed at the bottom of the first housing, and the four first universal wheels are symmetrically installed on a lower surface of the first base.

8. The efficient mowing machine according to claim 6, wherein the second housing assembly comprises a second housing, four support rods, two second bases, and two second universal wheels; and
the trimming mesh plate and the tumbling barrel are both fixedly connected to an inner side wall of the second housing, and the support frames are all installed on the inner side wall of the second housing.

9. The efficient mowing machine according to claim 8, wherein top ends of the four support rods are symmetrically and fixedly connected to a lower surface of the second housing, and bottom ends of the four support rods are symmetrically and fixedly connected to lower surfaces of the two second bases.

10. The efficient mowing machine according to claim 8, wherein the two second universal wheels are symmetrically and fixedly connected to the lower surfaces of the second bases.
